(19) United States
(12) Patent Application Publication
(10) Pub. No.: US 2016/0335907 A1
(43) Pub. Date: Nov. 17, 2016

(54) METHODS, SYSTEMS, AND COMPUTER READABLE MEDIA FOR FLIGHT TRAINING

(71) Applicant: Airbus (S.A.S.)

(72) Inventors: Katharyn WHELLER, PECHBONNIEU (FR); Jean-Charles MAZENQ, TOULOUSE (FR); Stephane METIVET, CASTANET TOLOSAN (FR); Jacques-Andre DUPUY, TECOU (FR)

(21) Appl. No.: 14/796,591

(22) Filed: Jul. 10, 2015

Related U.S. Application Data
(60) Provisional application No. 62/160,424, filed on May 12, 2015.

(51) Int. Cl. G09B 9/20; G09B 9/30; G09B 9/24

(52) U.S. Cl. CPC G09B 9/206; G09B 9/24; G09B 9/301

(57) ABSTRACT

A flight training system provides training for aircraft pilots. In some examples, the system includes one or more computers and one or more non-transitory computer readable media storing instructions that, when executed by the one or more computers, cause the one or more computers to provide the flight training. In operation, the computers execute a pedagogical trainer for presenting a structured sequence of training tasks to a trainee, a simulation trainer for providing free-play capacity in a computer simulated aircraft environment to the trainee, and an integration kernel is provided for transitioning the trainee between the pedagogical trainer and the simulation trainer.

### TECHNICAL FIELD

The subject matter described in this specification relates generally to computer systems for flight training, e.g., computer systems executing software that integrates pedagogical training software with a flight simulator.

### BACKGROUND

Effective flight training is important for preparing pilots for various flight situations. Computer systems for flight training can improve the speed and effectiveness of flight training. For example, a flight simulator is an environment made up of a set of devices and software applications capable of reproducing the performance of an aircraft. Flight simulators can provide exposure of various flight scenarios to pilots to prepare the pilots for those scenarios in actual flight.

Current computer systems for flight training include computer systems for pedagogical training that provide step by step interactive lessons with guidance and theoretical elements. Some other computer systems for flight training include computer systems that provide free access to a flight simulator, e.g., flight simulators that give free access to trainees for both guidance and theoretical elements. These two types of flight training systems are used in an isolated manner, e.g., where one is used after the other in a sequential manner.

### SUMMARY

A flight training system in one aspect provides services for training aircraft pilots. In some examples, the system includes one or more computers and one or more non-transitory computer readable media storing instructions that, when executed by the one or more computers, cause the one or more computers to provide the flight training. In operation, the computers execute a pedagogical trainer for presenting a structured sequence of training tasks to a trainee, a simulation trainer for providing free-play capacity in a computer simulated aircraft environment to the trainee, and an integration kernel for transitioning the trainee between the pedagogical trainer and the simulation trainer.

The subject matter described in this specification may be implemented in hardware, software, firmware, or any combination thereof. As such, the terms “function”, “node” or “module” as used herein refer to hardware, software and/or firmware components for implementing the feature(s) being described. In some examples, the subject matter described in this specification may be implemented using a non-transitory computer readable medium storing computer executable instructions that when executed by the processor of a computer cause the computer to perform steps.

Computer readable media suitable for implementing the subject matter described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described in this specification may be located on a single device or computing platform or may be distributed across multiple devices or computing platforms.

### BRIEF DESCRIPTION OF THE DRAWINGS

FIG. 1 is a block diagram of an example flight training computer system for flight training;

FIG. 2 is a block diagram of the example flight training computer system;

FIG. 3 is a block diagram illustrating example components of the kernel, the pedagogical trainer, and the simulation trainer;

FIG. 4 is a sequence diagram illustrating example messages passed between the components of the system in an example sequence;

FIG. 5 is a state diagram of an example trainee task state machine; and

FIG. 6 is a flow diagram of an example method performed by a computer system.

### DETAILED DESCRIPTION

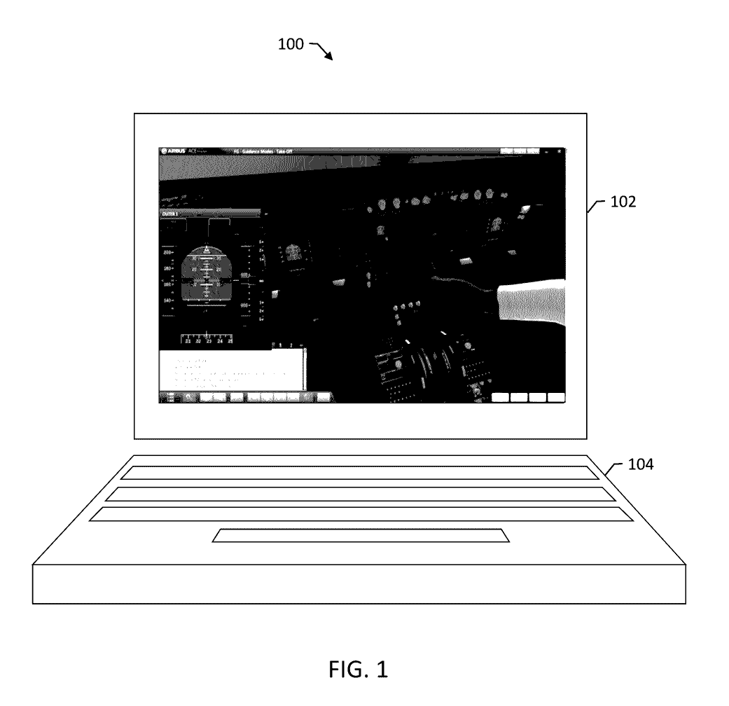

FIG. 1 is a block diagram of an example flight training computer system 100 for flight training. The computer system 100 includes a display device 102 and a user input device 104. For example, the computer system 100 can be a laptop, a desktop computer, a tablet computer, a mobile device, or any appropriate computer device for flight training.

The user input device 104 can be as simple as a keyboard and mouse or trackpad, and the computer system 100 can include any appropriate user input device. In some examples, the computer system simulates various user input devices in an aircraft cockpit. In some examples, the computer system 100 is integrated with a physical flight simulator environment including various user input devices that correspond to physical input devices in an aircraft cockpit.

To meet the demands for more effective flight training, the computer system 100 in some aspects is configured, by virtue of appropriate programming, to provide flight training in accordance with a constructivist learning paradigm. The computer system 100 uses simulation technology to help engage learners in a process that provides the interaction they desire with the feedback they need in real-time situations.

The computer system 100 enables individuals or crew to perform a lesson without an instructor in self-study mode by virtue of software that enables guidance, monitoring, and remediation capacity. The computer system 100 fully integrates pedagogical aspects of flight training within a traditional simulation environment.

For example, suppose that the computer system 100 is conducting training on the Airport Navigation Function (ANF) which helps the flight crew to navigate on airports, and thus improves flight crew awareness on ground. The computer system performs pedagogical training, e.g., by instructing the trainee that the flight crew must always use external visual cues for taxi as the primary reference.

After providing the trainee with pedagogical instruction on using the ANF, the computer system 100 transitions the trainee to a simulation where the trainee interacts with as simulated ANF user interface. The computer system then transitions the trainee out of the simulation when the simulation reaches a certain simulation state, e.g., when a simulated aircraft reaches a certain gate.

In another example, the computer system 100 provides pedagogical instruction on using the electronic centralized aircraft monitor (ECAM) system in the case of abnormal operation. During certain parts of the pedagogical instruction, the computer system 100 transitions the trainee to a simulation where the trainee interacts with the ECAM system. The computer system then transitions the trainee out of the simulation when the simulation reaches a certain simulation state, e.g., when the trainee has shut down an appropriate engine.

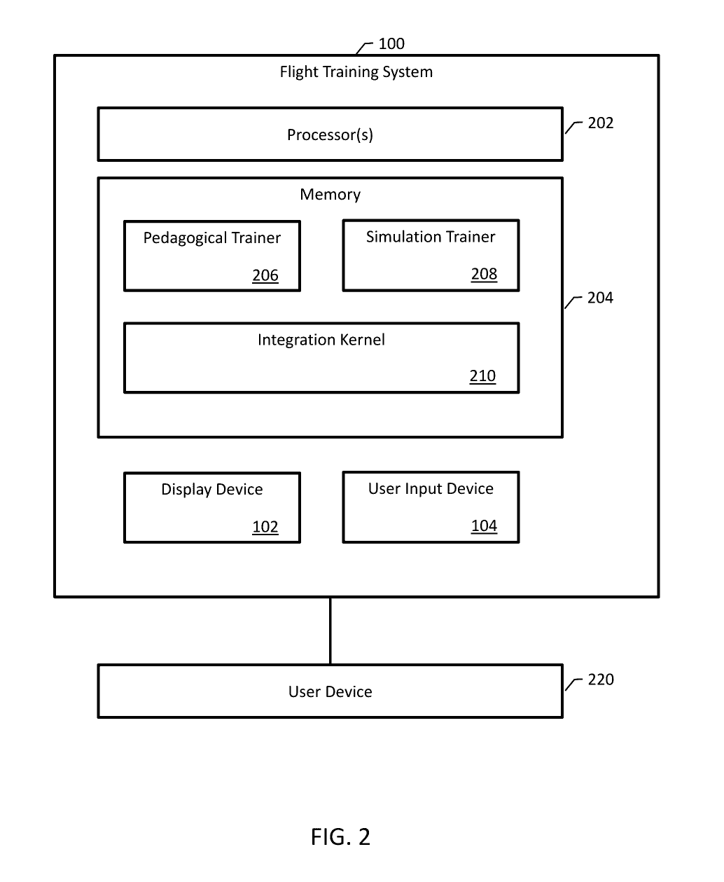

FIG. 2 is a block diagram of the example flight training computer system 100. The computer system 100 includes one or more processors or processor cores 202 and a memory 204 for storing flight training software. The memory 204 can be implemented as any appropriate memory structure. For example, the memory 204 can include one or more non-transitory computer readable media, e.g., hard drives or flash drives, storing the software. The software can be loaded into random access memory (RAM) for execution by the processors 202.

The computer system 100 includes a pedagogical trainer 206, a simulation trainer 208, and an integration kernel 210 for integrating the pedagogical trainer 206 and the simulation trainer 208. The pedagogical trainer 206 presents a structured sequence of training tasks to a trainee. The pedagogical trainer 206 presents a step by step interactive lesion with guidance and theoretical elements.

The simulation trainer 208 provides free-play capacity in a computer simulated aircraft environment to the trainee. The simulation trainer 208 provides aircraft system logic simulation with free access to guidance and theoretical elements. For example, the simulation trainer 208 provides an interactive virtual 3D cockpit in a crew environment, e.g., with two pilots. The simulation trainer 208 in some aspects simulates crew interaction in a fully integrated environment.

The integration kernel 210 transitions the trainee between the pedagogical trainer and the simulation trainer. The integration kernel 210 enables a free-play session for the trainee in the simulation trainer 208 within a guided lesson provided by the pedagogical trainer 206. The integration kernel 210, used with the pedagogical trainer 206 and the simulation trainer 208, are used to integrate different types of training into one training exercise to provide training in a logical manner instead of the conventional sequential manner.

In operation, the computer system 100 uses the aircraft simulation state of the simulation trainer 208 to control the pedagogy rather than simply using the interaction within the cockpit environment. For example, the computer system 100, using the integration kernel 210, displays any appropriate type of media in response to a preprogrammed simulation state of the simulation trainer 208, e.g., the computer system displays a hypertext markup language (HTML) window with pure theoretical contents in the simulation.

In another example, the computer system 100 moves to a next step based on the simulation state of the simulation trainer 208, thus enabling free-play possibilities within a guided lesson. Other crew member actions can be included within the guided lesson to simulate a real environment.

The execution of the pedagogical trainer 206 and the simulation trainer 208 allows animating various human-machine interaction scenarios for the trainee:
Virtual cockpit
Pedagogical window with pure theoretical contents
Action or objective lists
Feedbacks or highlights
Guidance message
Aural messages (Virtual Instructor)

The computing system 100 of FIG. 2 can be a general purpose computing system that becomes a special purpose computing system for the purposes of flight training by virtue of special purpose software installed on the system 100. The integration kernel 210 provides a technical effect to the computing system 100 by allowing both a pedagogical trainer and a simulation trainer to execute on the same computing platform, which reduces the needs for sophisticated computing equipment in performing flight training.

Moreover, the integration kernel 210 provides for streamlined communication and integration between the pedagogical trainer and simulation trainer, which reduces the needs for computing resources such as a random access memory space and processing cycles on the computer system 100. In some examples, the reuse of conventional pedagogical and simulation training software reduces the development time of training software in accordance with a constructivist learning paradigm.

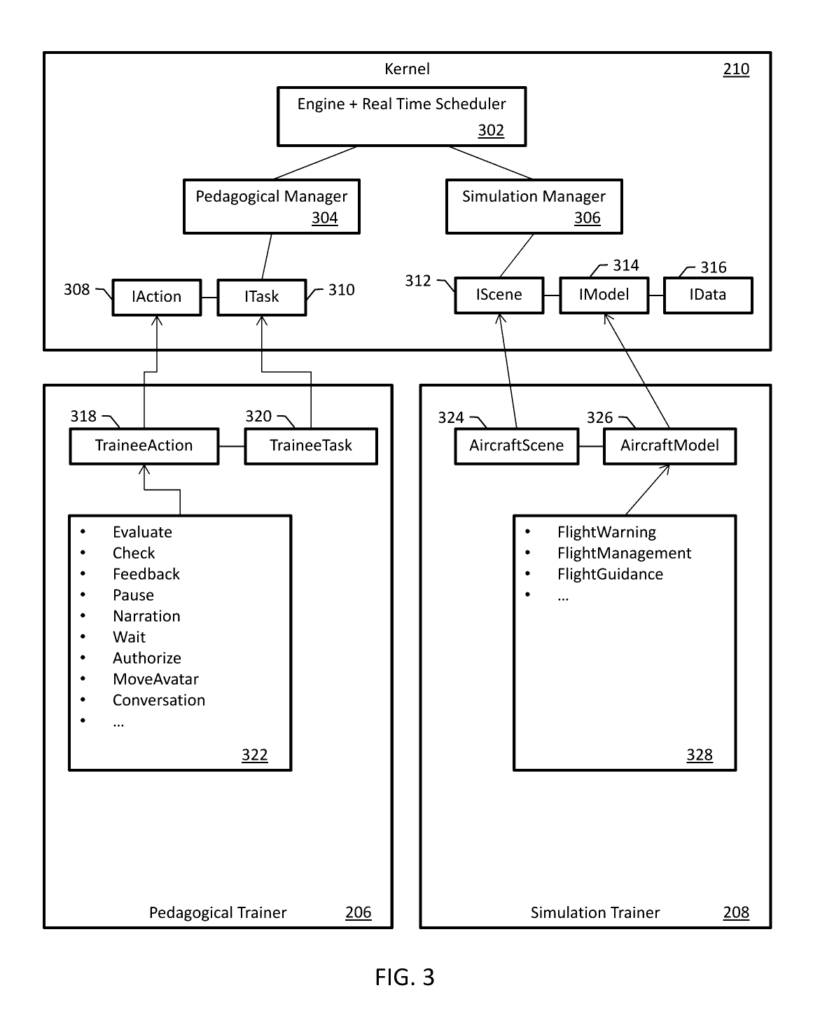

FIG. 3 is a block diagram illustrating example components of the kernel 210, the pedagogical trainer 206, and the simulation trainer 208. The kernel includes an engine and real time scheduler 302, a pedagogical manager 304, and a simulation manager 306.

The pedagogical manager 304 maintains ITask 310 and IAction 308 objects for the pedagogical trainer 206. The simulation manager 306 maintains IScene 312, IModel 314, and Data 316 objects for the simulation trainer 208. In general, these objects can be implemented using any appropriate approach for designing software. For example, the software can be implemented using a contract programming approach for designing software, where the objects are contracts. The objects can be abstract and implemented by the pedagogical trainer 206 and simulation trainer 308.

The pedagogical trainer 206 maintains TraineeAction 318 and TraineeTask 320 objects. The TraineeAction 318 object tracks and evaluates actions taken by the trainee. The TraineeTask 320 object tracks tasks and moves the trainee from one task to the next in a sequence of tasks. The trainee can take any of various actions in response to tasks. Example tasks 322 presented to the trainee or performed by the trainee include an evaluate task, a check task, a feedback task, a pause task, a narration task, a wait task, an authorize task, a MoveAvatar task, and a conversation task.

The simulation trainer 208 maintains AircraftScene 324 and AircraftModel 326 objects. The simulation trainer 208 updates the AircraftModel 216 based on simulation events 328, e.g., FlightWarning, FlightManagement, and FlightGuidance events. The aircraft environment is composed of systems for which interactive equipment can be manipulated by the trainee. When a logical modeling of the real aircraft is integrated, the trainee manipulation of equipment is translated into systematic modifications of the context of the simulated aircraft and the associated simulated data.

The tasks of the TraineeTask 320 objected include N sequential actions (steps). In accordance with objectives of lessons, step by step tasks are included in their definitions by declaring an entry point and an end point. The threads of lessons are in these cases considered as the progress of the sequential steps of the tasks. In some example, the kernel 210 advances the system from one step to the next in response to determining that a current step has been completed.

The kernel 210 recognizes several inherited steps that allow creating complex actions to cover required objectives of a lesson. The progress of a task in some aspects is automatic (for demonstration mode) or based on trainer manipulation of the aircraft equipment and/or logical expressions which can be calculated from the combination of values of simulation data.

In addition to the progression of a task, the kernel 210 implements a set of triggers. The kernel 210 calculates and/or verifies the triggers in real-time or near real-time and plays a collection of effects when they are validated (on rising edge, on falling edge, until checked, until unchecked). For example, a trigger can be added to a task to trigger a system fault or a hazardous behavior at a predefined simulated time. The calculation of the sequential steps of a task and the collection of triggers in some aspects is considered as the calculation of the pedagogy of the lesson and is scheduled by the real-time scheduler 320 used for the calculation of the behavior of the simulated aircraft.

In some examples, the aircraft environment comprises systems for which interactive equipment is manipulated by trainee actions. When a logical modeling of the real aircraft is integrated, the trainee actions on equipment are translated into systematic modifications of the context of the simulated aircraft and the associated simulated data.

In some examples, the steps of a task are architected and organized in two major calculation modes:
Simulation data mode:
   When this mode is selected, all trainee interactions in the 3D virtual cockpit are translated into simulation data modifications in accordance with the behaviors of the manipulated equipment. The steps of a task are validated when one or more variables of the simulation state of the simulation trainer reach preprogrammed values or when dedicated logical expressions are becoming true. The main steps of a task based on the simulation data mode are defined with an EvaluateDataAction data structure. The EvaluateDataAction is accompanied with a validation timer in order to give the opportunity to a user to place the devices in the right and expected positions. Specific effects are implemented when unexpected equipment is used by the trainee during the processing of lessons, e.g., providing guidance messages or highlights.
Check mode:
   When this mode is selected, all trainee interactions in the virtual cockpit of the aircraft environment are translated into equipment check. The steps of a task are validated when the expected equipment is checked by the user. Specific effect is implemented when wrong equipment is checked by the user during the processing of lessons, e.g., providing guidance messages or highlights.

The lesson calculation mode is changeable during the processing of the lessons by integrating specific orders to set the user interaction behaviors. In some examples, it is possible to set an exclusive calculation mode or to compose the calculation mode with both major calculation modes. The trainee interaction mode may also be set in order to define the degrees of freedom when interacting in the virtual cockpit.

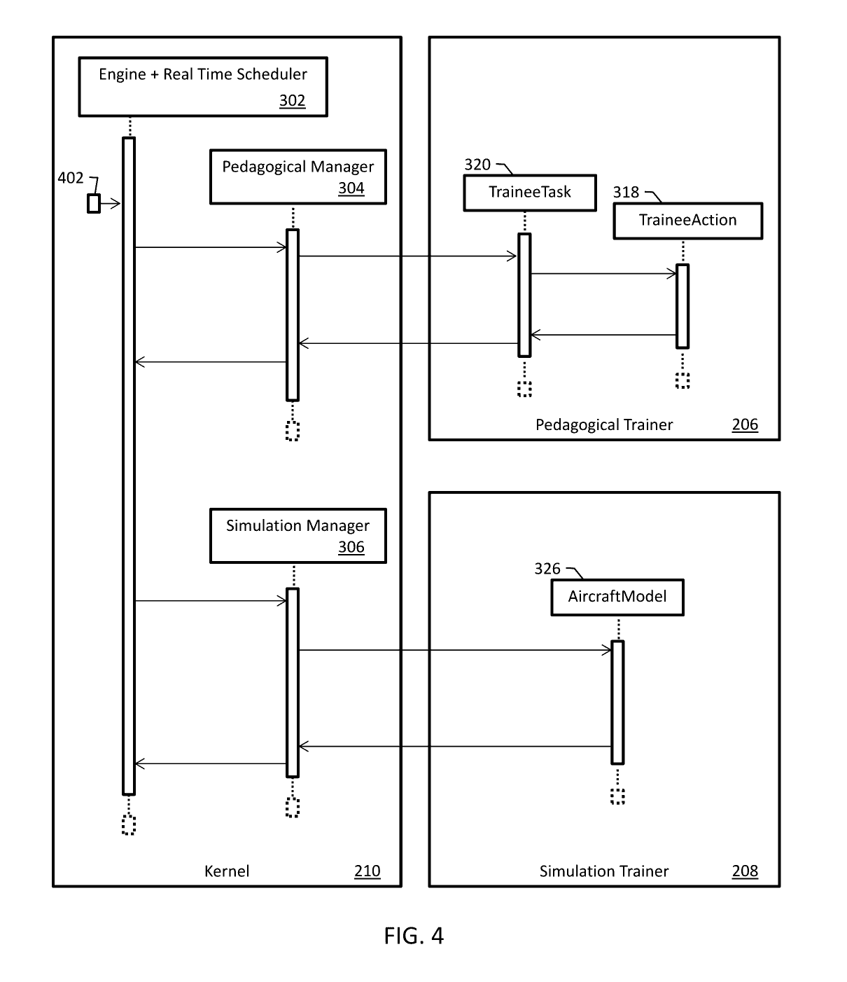

FIG. 4 is a sequence diagram illustrating example messages passed between the components of the system in an example sequence. The sequence diagram shows messages being passed over time from the top of the diagram to the bottom of the diagram. For purposes of illustration, the messages are overlaid on the kernel 210, pedagogical trainer 206, and simulation trainer 208 to illustrate which components are sending which messages.

A timing tick function 402 is called by the kernel 210 at periodic intervals, e.g., once every 50 ms for a frequency of 20 Hz. To be compliant with real-time, the elapsed time to calculate both parts is less or equal to the desired calculation step time (1/frequency).

In the example sequence illustrated in FIG. 4, first, the real time scheduler 302 requests the pedagogical manager 304 to perform its function. The pedagogical manager 304 executes the TraineeTask 320. The TraineeTask 320 executes the current action by the TraineeAction 318. Return messages are passed back to the real time scheduler 302.

Second, the real time scheduler 302 requests the simulation manager 306 to perform its function. The simulation manager 306 requests all of the aircraft models 326 to perform their functions. For example, the simulation manager 306 loops through each model and sends a request to each model.

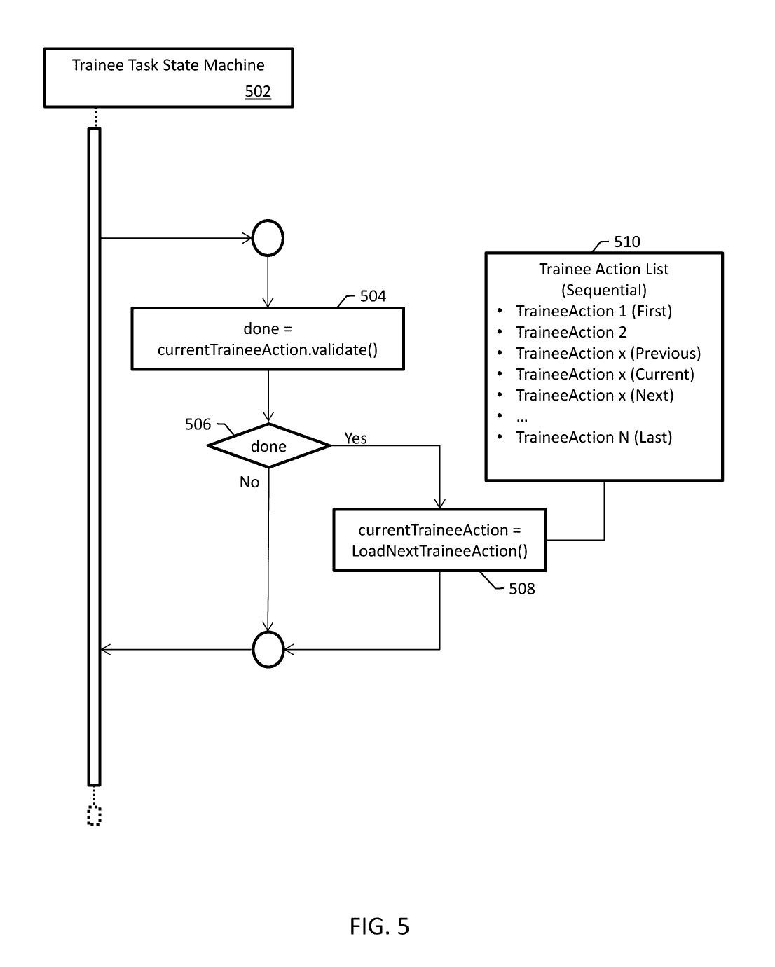

FIG. 5 is a state diagram of an example trainee task state machine 502. The state machine 502 for example is implemented in the kernel 210 or the pedagogical trainer 206 or both. The kernel 210, e.g., by the real time scheduler 302, updates the current trainee task, which includes trainee actions.

While the trainee is completing a trainee action, the state machine 502 loops between validating 504 the current trainee action and determining whether the action is done 506. When the trainee completes the action, the state machine 502 determines that the action is done and loads the next trainee action 508 from a trainee action list 510. The trainee action list 510 includes a sequential list of trainee actions.

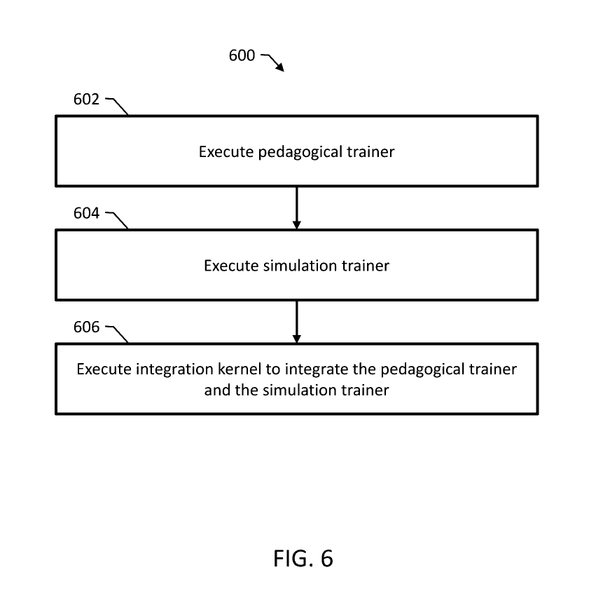

FIG. 6 is a flow diagram of an example method 600 performed by a computer system. The computer system executes a pedagogical trainer (602) and a simulation trainer (604). The computer system executes an integration kernel (606) to integrate the pedagogical trainer with the simulation trainer by transitioning a trainee between the pedagogical trainer and the simulation trainer.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise.

What is claimed is:

1. A system for flight training, the system comprising:
one or more computers; and
one or more non-transitory computer readable media storing instructions that, when executed by the one or more computers, cause the one or more computers to perform flight training, the instructions comprising:
a pedagogical trainer for presenting a structured sequence of training tasks to a trainee;
a simulation trainer for providing free-play capacity in a computer simulated aircraft environment to the trainee; and
an integration kernel for transitioning the trainee between the pedagogical trainer and the simulation trainer.

2. The system of claim 1, wherein transitioning the trainee between the pedagogical trainer and the simulation trainer comprises enabling a free-play session for the trainee in the simulation trainer within a guided lesson provided by the pedagogical trainer.

3. The system of claim 1, wherein transitioning the trainee between the pedagogical trainer and the simulation trainer comprises monitoring a simulation state of the simulation trainer and transitioning the trainee from the simulation trainer to the pedagogical trainer when the simulations state reaches a preprogrammed pedagogical state.

4. The system of claim 1, wherein transitioning the trainee between the pedagogical trainer and the simulation trainer comprises monitoring, in real-time or near real-time, a simulation state of the simulation trainer for one or more triggers and, in response to validating one of the triggers, playing one or more effects on the simulation trainer based on data from the pedagogical trainer.

5. The system of claim 4, wherein playing one or more effects on the simulation trainer comprises causing a system fault or a hazardous behavior at a preprogrammed simulated time.

6. The system of claim 1, wherein the integration kernel comprises an embedded state machine for activating a second step of a task in response to determining that a first step has been achieved by the trainee in accordance with a preprogrammed lesson.

7. The system of claim 1, wherein the simulation trainer is configured to present, on a display device, a virtual 3D cockpit comprising simulated equipment, so that one or more trainee interactions in the 3D virtual cockpit are translated into simulation data modifications in accordance with respective behaviors of the simulated equipment.

8. The system of claim 1, wherein the simulation trainer is configured to present, on a display device, one or more feedback displays, highlight displays, and guidance messages.

9. The system of claim 1, wherein the pedagogical trainer is configured to present a pedagogical window with one or more pure theoretical contents.

10. The system of claim 1, wherein the pedagogical trainer is configured to execute a virtual instructor for providing, by one or more audio speakers, one or more aural messages to the trainee.

11. A method for flight training performed by one or more computers, the method comprising:
executing, by the one or more computers, a pedagogical trainer for presenting a structured sequence of training tasks to a trainee;
executing, by the one or more computers, a simulation trainer for providing free-play capacity in a computer simulated aircraft environment to the trainee; and
executing, by the one or more computers, an integration kernel for transitioning the trainee between the pedagogical trainer and the simulation trainer.

12. The method of claim 11, wherein transitioning the trainee between the pedagogical trainer and the simulation trainer comprises enabling a free-play session for the trainee in the simulation trainer within a guided lesson provided by the pedagogical trainer.

13. The method of claim 11, wherein transitioning the trainee between the pedagogical trainer and the simulation trainer comprises monitoring a simulation state of the simulation trainer and transitioning the trainee from the simulation trainer to the pedagogical trainer when the simulations state reaches a preprogrammed pedagogical state.

14. The method of claim 11, wherein transitioning the trainee between the pedagogical trainer and the simulation trainer comprises monitoring, in real-time or near real-time, a simulation state of the simulation trainer for one or more triggers and, in response to validating one of the triggers, playing one or more effects on the simulation trainer based on data from the pedagogical trainer.

15. The method of claim 14, wherein playing one or more effects on the simulation trainer comprises causing a system fault or a hazardous behavior at a preprogrammed simulated time.

16. The method of claim 11, wherein the integration kernel comprises an embedded state machine for activating a second step of a task in response to determining that a first step has been achieved by the trainee in accordance with a preprogrammed lesson.

17. The method of claim 11, wherein the simulation trainer is configured to present, on a display device, a virtual 3D cockpit comprising simulated equipment, so that one or more trainee interactions in the 3D virtual cockpit are translated into simulation data modifications in accordance with respective behaviors of the simulated equipment.

18. The method of claim 11, wherein the simulation trainer is configured to present, on a display device, one or more feedback displays, highlight displays, and guidance messages.

19. The method of claim 11, wherein the pedagogical trainer is configured to present a pedagogical window with one or more pure theoretical contents.

20. The method of claim 11, wherein the pedagogical trainer is configured to execute a virtual instructor for providing, by one or more audio speakers, one or more aural messages to the trainee.

21. One or more non-transitory computer readable media storing instructions that, when executed by the one or more computers, cause the one or more computers to perform flight training, the instructions comprising:
a pedagogical trainer for presenting a structured sequence of training tasks to a trainee;
a simulation trainer for providing free-play capacity in a computer simulated aircraft environment to the trainee; and
an integration kernel for transitioning the trainee between the pedagogical trainer and the simulation trainer.
